(19) United States
(12) Patent Application Publication
(10) Pub. No.: US 2016/0346754 A1
(43) Pub. Date: Dec. 1, 2016

(54) PROCESS AND APPARATUS FOR PRODUCTION OF BIODIESEL AND TREATMENT OF WASTE THEREBY GENERATED

(71) Applicants: Galen Michael Bowen, Ukiah, CA (US); Daniel Patrick Bowen, Mesa, AZ (US); Edward Valentin Mills, Chico, CA (US)

(72) Inventors: Galen Michael Bowen, Ukiah, CA (US); Daniel Patrick Bowen, Mesa, AZ (US); Edward Valentin Mills, Chico, CA (US)

(73) Assignee: Springboard Biodiesel, LLC, Chico, CA (US)

(21) Appl. No.: 14/720,851

(22) Filed: May 25, 2015

(51) Int. Cl. B01J 19/24; C10L 1/02

(52) U.S. Cl. CPC B01J 19/24; C10L 1/026; C10L 2200/0476; C10L 2270/026; C10L 2290/547; C10L 2290/541; C10L 2290/543; B01J 2219/24; B01J 2219/0002; B01J 2219/00029

(57) ABSTRACT

Glycerolipids and fatty acids are purified in a continuous flow by removal of particulates and moisture. Following this, they are esterified and transesterified in batches, after which the fatty acid alkyl esters produced are separated from the glycerin phase byproduct and are purified through a continuous flow removal of soaps, trace glycerin, salts, and free alcohol. Excess alcohol is recovered from the glycerin phase and esters, after which it is purified and reused. Waste soaps are acidulated and recovered as fatty acids, and waste glycerin is refined and separated from trapped oils, which are recovered. A plurality of individual modules, each specialized for specific tasks, and fluidly coupled by plumbing, perform these processes. The throughput capacity is expandable in small increments through addition and integration of additional modules into the system and/or adjustments to the number of shifts worked by operators.

### CROSS REFERENCE TO RELATED APPLICATIONS

This patent application claims the priority of U.S. Provisional Patent Application No. 62/009,202 entitled “PROCESS AND APPARATUS FOR PRODUCTION OF BIODIESEL AND TREATMENT OF WASTE THEREBY GENERATED” filed Jun. 7, 2014, which is herein incorporated by reference.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### REFERENCE TO SEQUENCE LISTING, A TABLE, OR A COMPUTER PROGRAM LISTING COMPACT DISC APPENDIX

Not Applicable

### STATEMENT REGARDING PRIOR DISCLOSURES BY THE INVENTOR OR A JOINT INVENTOR

One of the joint inventors, Edward V. Mills, verbally disclosed some of the subject matter to approximately 125 guests invited to tour a facility where a prototype of the subject matter had been construction. This disclosure occurred on May 1, 2014. This was less than 1 year prior to the Jun. 7, 2014 filing date of Provisional Application No. 62/009,202, the priority of which is claimed in this application.

### BACKGROUND OF THE INVENTION

1. Field of the Invention

The invention relates to biodiesel production and the equipment that facilitates it.

2. Description of Related Art

Many viable methods and related apparatuses exist for producing biodiesel from oils of plant or animal origin (commonly referred to as feedstock). As the biodiesel industry has matured, competition, regulation, fluctuation of feedstock cost and availability, and other factors have demanded more clean, efficient, and flexible processes and equipment in order for biodiesel production to be economically feasible. Many methods and devices are severely limited in the acidity range of feedstock that they can accept. Others cannot be readily scaled to fit available site regulatory or utility limitations. Many do not deal effectively with the waste products generated by the biodiesel production process. And finally, many are prohibitively expensive. Weaknesses such as these have been the root of a large number of failed business endeavors to produce and sell biodiesel.

In view of the forgoing, there is a need for improved methods of biodiesel production that can accommodate wide ranges of feedstock quality; that can scale to available site and feedstock supply limitations; that process the generated waste into a form which can legally, easily and responsibly be disposed of; and which streamline the scope, and resultant cost, of the needed equipment.

### BRIEF SUMMARY OF THE INVENTION

The invention teaches a method for making biodiesel from plant or animal based oils. The method disclosed allows oils with free fatty acid levels ranging from 0% to more than 10% to be used as feedstock. Many existing methods can only utilize oils with much lower free fatty acid levels. Additionally, the method disclosed can accommodate oils with contamination from moisture, insolubles, and unsaponifiables as high as 2%. The method first removes particulates from the feedstock in a continuous flow stream, and then discharges this feedstock into a flow buffer module. A batch of purified feedstock from the flow buffer module enters a reactor module, which first removes water contamination through evaporation performed under vacuum. Following this, the purified and dried feedstock is subjected to a transesterification reaction. Prior to the transesterification, it may be subjected to an esterification reaction, depending on its initial free fatty acid level.

Following the transesterification, a portion of the free alcohol present in the mixture is extracted by evaporation performed under vacuum. Next, the liquid in the reactor module is allowed to separate, and the phase containing the glycerin and soaps is removed from the raw biodiesel phase.

The raw biodiesel phase is removed from the reactor module and sent a to flow buffer module. Raw biodiesel from the buffer module is dispensed at a controlled rate through a dry wash module. The dry wash module utilizes solid media to remove trace soaps, salts, and glycerin from the raw biodiesel as it flows through. Following the dry wash module, the stream of raw biodiesel flows through a biodiesel dealkylation module to remove trace alcohol. The biodiesel then flows through a final processing module, where it is filtered, passes though yet more solid media to ensure purity and remove sterol glucosides, and receives the addition of an oxidative stabilizing chemical agent. At this point, the biodiesel is finished and ready for storage or sale.

The glycerin phase that was removed from the raw biodiesel is sent to a treatment module, where the remaining free alcohol is extracted by evaporation under vacuum, the soaps are acidulated into free fatty acids, and the water thereby generated is also extracted by evaporation under vacuum. This allows salts to precipitate out of the remaining glycerin phase. These are removed, and the remaining high free fatty acid oils and refined glycerin are separated. The refined glycerin has significant value as a bulk commodity. The high free fatty acid oils are also saleable, or they can be used to fuel a boiler, which in turn provides heat for the process. In many other biodiesel production methods and their related apparatuses, the glycerin phase represents a liability rather than a value. All wastes produced by the system (other than water), are in solid form and considered non-hazardous and are thus readily disposable.

Water vapor and alcohol vapor from the reactor module, as well as water vapor from the glycerin treatment module are condensed and recaptured in a medium temperature condenser module. It is important to note that a single condenser module is employed to condense both of these different types of vapor, thereby consolidating the refrigeration equipment required. The condensed water vapor can be disposed of as common wastewater. This module produces the vacuum employed in the evaporation of these liquids. Deep vacuum is generated to evaporate water. In order to condense both fluids, a minimum temperature of 0 degrees Celsius (32 degrees Fahrenheit) exists for this module, to avoid ice formation from the water vapor. Due to this minimum temperature, only moderate vacuum can be employed for the evaporation of alcohol vapors, since they will not condense under deep vacuum.

Alcohol vapors from the glycerin treatment module and the biodiesel dealkylation module, where deeper vacuum is employed, are condensed and recaptured in a low temperature condenser module. This module generates the vacuum employed in the evaporation of these liquids. Since only alcohol is condensed, a temperature much lower than 0 degrees Celsius (32 degrees Fahrenheit) can be employed, thereby permitting these vapors to condense fully, despite the deep vacuum. The alcohol condensed by both modules is refined in an alcohol purification module, after which it can be reused.

The apparatus utilized by the method is made up of distinct modules, each with specific functions. These modules are fluidly coupled to one another by plumbing, and thus can be physically arranged in many ways. This is a flexibility improvement over other systems which utilize fewer, larger components, thus restricting site options.

The total quantity of feedstock or biodiesel undergoing various stages of the process at any given time does not exceed twice the daily finished biodiesel output of the system. This relatively low quantity saves space and may ease regulatory compliance. This is an improvement over many methods which gradually advance large quantities feedstock or raw biodiesel through several successive tanks over the course of several days.

The apparatus, being comprised of many small, fluidly coupled modules, has the ability to be scaled up in small increments with the simple addition of more modules. The position of these new modules is flexible, since they must only be plumbed to the rest of the system. This scalability allows a user to start with a small system, and then gradually enlarge it as his business grows. This is a distinct advantage over many processing systems which have rigidly defined capacities.

The method and apparatus disclosed are conducive to automated control by means of a programmable logic controller or other computer program. For those tasks that require human labor, this can be accomplished within the span of a standard work shift (9 total hours, including a 1 hour lunch break). Outside of this shift, the system can operate unattended, performing only those tasks that are readily preformed through automation. This is an improvement over methods and apparatuses which require human labor at intervals which cannot fit into a standard work shift.

The utilization of a centralized medium temperature condenser module for both alcohol and water vapors as well as a centralized low temperature condenser module for alcohol vapors extracted under deeper vacuum represents an efficiency advantage over other methods. Since various modules produce vapors which must be condensed, duplication of condensing equipment is eliminated. In addition, to the extent that the condenser modules' capacity permits it, if the system is enlarged, new modules which produce vapors can simply be plumbed in to the existing condenser modules. Since only a small portion of the vapors produced by the system require a temperature under degrees 0 Celsius (32 degrees Fahrenheit), and since the refrigeration equipment needed to achieve these lower temperatures is more expensive to purchase and operate, utilizing a separate, medium temperature condenser unit for the vast majority of the cooling load results in initial and ongoing cost savings.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a flow diagram describing one embodiment of the process of producing biodiesel and treating the wastes that are generated.

FIG. 2 is a schematic diagram of the apparatus depicting the flow paths between the fluidly coupled modules in accordance with one embodiment of the invention.

FIG. 3 is a 24 hour timetable depicting the scheduling of processes and technician tasks in accordance with one embodiment of the invention.

### DETAILED DESCRIPTION OF THE INVENTION

The invention is directed at a process for producing biodiesel and treating the waste generated by this process, as well the apparatus for performing this process. The major steps executed in the biodiesel production process comprise: storing feedstock, removing particulates from the feedstock, interfacing the continuous flow of feedstock from the particulate removal process with the intermittent batch movements of feedstock by the next step, removing water from the feedstock (dehydration), performing one or more esterification reactions on the feedstock (if necessary), performing one or more transesterification reactions on the feedstock, removing the glycerin phase produced by the transesterification from the raw biodiesel, interfacing the intermittent batch movements of the raw biodiesel from the previous step with the continuous flow of the raw biodiesel in the subsequent steps, washing the fuel using solid media (drywash), removing trace alcohol from the raw biodiesel, and performing final quality assurance processes on the biodiesel.

The major steps executed in the waste treatment include: conversion of sludge from feedstock particulate removal to solid form, removal of alcohol present in the glycerin phase, acidulation of soaps present in the glycerin phase, dehydration of the glycerin phase, removal of salts from the raw glycerin, separation of the raw glycerin into refined glycerin and high free fatty acid oils, disposal of water from all dehydration steps, recapture through condensation of the methanol and water vapor removed during other methanol removal and dehydration steps, and purification of recaptured methanol.

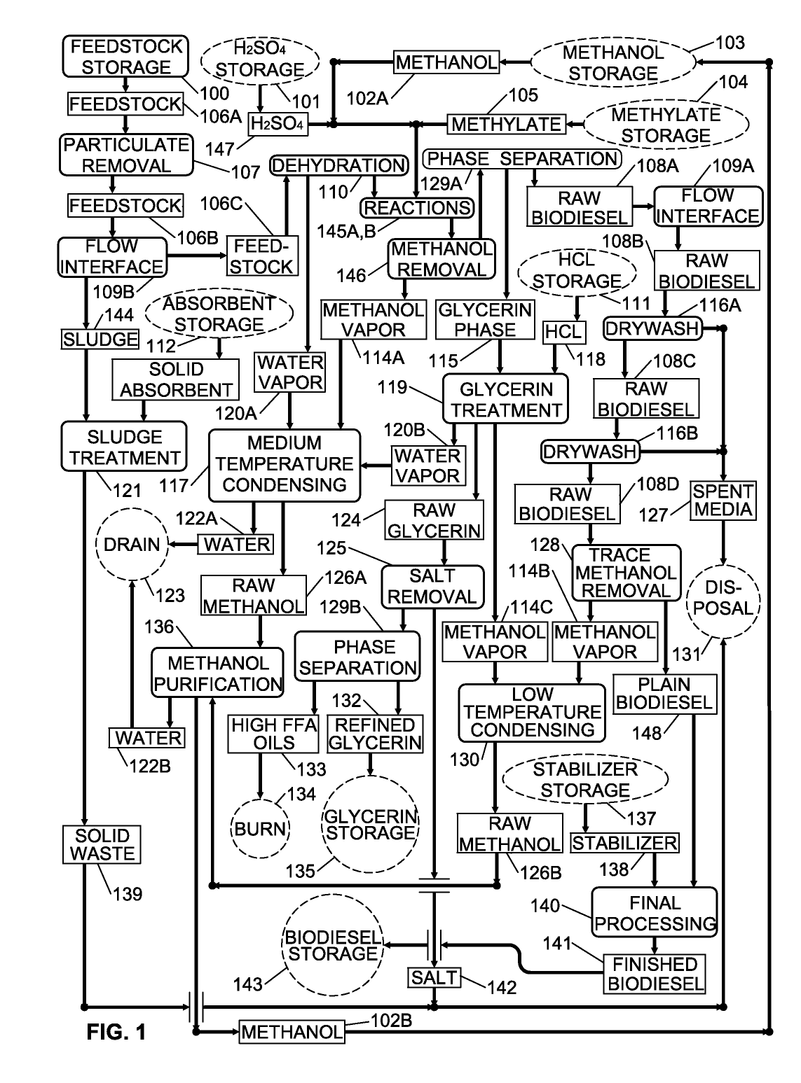

FIG. 1 depicts one possible embodiment of the process. With the exception of feedstock storage, the storage of ingredients and of final products is peripheral to the invention, and these storage processes are depicted for clarity only, since the process implies them.

The primary ingredient employed by the process is feedstock 106. Feedstock refers to oils of animal or vegetable origin. One type of feedstock which is popular due to its availability and low cost is used cooking oil (UCO). Feedstock, especially UCO, usually has some degree of acidity, due to the presence of free carboxylic acid chains, or fatty acids (FFAs). It also usually has some level of contamination from particulates and water. In the embodiment shown, during feedstock storage 100 the feedstock is preheated. Since most methods of particulate removal 107 require the feedstock to be significantly warmer than room temperature, preheating greatly reduces the heating load required during particulate removal 107. Additionally, during feedstock storage 100, it may be advantageous to employ agitation or recirculation to prevent the concentration of particulates at the bottom of the storage vessel. By keeping the particulate concentration more homogenous, the task of particulate removal 107 is simplified.

Particulates in the feedstock often hold moisture or other compounds which interfere with the chemical reactions used to make biodiesel. Additionally, finished biodiesel must be as free from particulates as possible. Particulate removal 107 may be accomplished by a number of possible methods. The most common are filtration or centrifugation. Regardless of which method is employed, it is difficult to remove particulates without removing some feedstock along with them. Thus, particulates are removed in the form of sludge 144. A particulate removal 107 method which minimizes the quantity of feedstock present in the sludge is preferred. This will diminish the task of sludge treatment 121.

Due to the rigorous regulations that commonly accompany the disposal of liquid waste, sludge treatment 121 is employed to convert the sludge to a substance that can be disposed of in solid form. This may involve separation and removal of the liquid phase (which may subsequently be rejoined to the feedstock), absorption of the liquid phase by a solid, or a combination of the two. In the embodiment depicted, only absorption of the liquid phase by a solid absorbent 113 is employed. Numerous solids are suitable; one viable option is diatomaceous earth. By mixing an appropriate quantity of solid absorbent with the sludge, the liquid portion of the sludge is completely absorbed, and the entire mass is converted to solid waste 139. The nature of the disposal 131 of solid waste 139 as well as the nature of the absorbent storage 112 are not relevant to the invention. They are merely depicted because the invention implies them.

Most methods of particulate removal 107 involve gradually passing the feedstock through the particulate removal device at a controlled rate. The later steps of dehydration 110, reactions 145, and methanol removal 146, though, are conducted on discrete batches of fluid. This requires flow interface 109A to adapt the continuous flow of feedstock 106B from particulate removal 107 to the discrete batch movement of feedstock 106C as required by dehydration 110. Flow interface 109A may take the form of a buffering vessel.

Following the removal of particulates from the feedstock, it is subjected to dehydration 110. Moisture is removed in the form of water vapor 120A. This is accomplished by elevating the temperature of the feedstock 106C and applying vacuum to it. The thoroughness of the dehydration 110 has a major effect on the efficacy of the reactions 145 to follow. Following dehydration 110, alcohol and acid are mixed with the feedstock to perform an esterification reaction 145A. In the embodiment shown the alcohol is methanol 102A and the acid is sulfuric acid 147. The mixture is agitated and maintained at an appropriate temperature for the reaction 145A. The esterification reaction 145A reduces the level of FFAs present in the feedstock 106C by converting many of them to raw biodiesel 108A. In the event that the initial FFA level of the feedstock 106C is low enough, the esterification reaction 145A may be skipped. Following the esterification reaction 145A, a transesterification reaction 145B is conducted using an alkoxide catalyst, methylate 105. Common forms of methylate 105 are sodium methylate and potassium methylate. The embodiment shown employs sodium methylate. In the embodiment shown, only one transesterification reaction 145B is performed, but sequential transesterifications may be used to achieve a more complete result.

Upon conclusion of transesterification reaction 145B, the feedstock 106C has been converted to raw biodiesel 108A. This also contains a small quantity of methanol 102A, soaps, and salts. A secondary glycerin phase 115 is now present as well, and this comprises glycerin, oils, soaps, methanol 102A and some salts. A portion of the methanol 102A is removed from the mixture by methanol removal 146 in the form of methanol vapor 114A, while an appropriate concentration of methanol 102A is allowed to remain. The lower the remaining concentration of methanol 102A, the greater the difference will be in density between the glycerin phase 115 and the raw biodiesel 108A. This density difference will help promote separation of the two phases 115 and 108A through gravity. If too little methanol 102A is allowed to remain, however, soaps previously dissolved in raw biodiesel 108A may begin to precipitate, causing the raw biodiesel 108A to take on a gelatinous quality, and actually inhibiting separation of the phases 115 and 108A. Thus, the concentration of methanol 102A allowed to remain in the mixture is controlled by regulating the combination of temperature and vacuum present.

Methanol removal 146 also has the effect of cooling the liquid mixture through the absorption of latent heat by methanol vapor 114A. Since some of the subsequent steps of the process require a cooler temperature than the reactions 145, this cooling effect is useful.

Following methanol removal 146, phase separation 129A takes place, wherein gravity causes the denser glycerin phase 115 to separate from the raw biodiesel 108A. After these two phases become distinctly separate, the glycerin phase 115 is removed. The large batch of raw biodiesel 108A just created now proceeds forward through the remaining steps of the process as a continuous stream. This flow interface 109B between rapid movement of large batches of liquid and a slower continuous feed stream may be accomplished by a buffering vessel.

Raw biodiesel feedstream 108B now goes through the first drywashing step 116A. In the embodiment shown, there are two drywash steps, 116A and 116B, although in practice it may be possible to have only one drywash step, or it may be advantageous to have three or more. In drywash step 116A the feed stream of raw biodiesel 108B flows through a bed of solid media which, in the embodiment shown, may be made up of loose cellulosic particles. This serves to remove the bulk of the soaps and other contaminants from raw biodiesel 108B through absorption. The raw biodiesel 108C exiting drywash step 116A usually still contains trace amounts of contamination, however, and so drywash step 116B is employed to reduce this contamination to acceptable levels. In drywash step 116B, the feedstream of raw biodiesel 108C flows through a bed of solid media which, in the embodiment shown, may be made up of loose ion-exchange resin granules. In addition to ion exchange, this media also functions through absorption and adsorption of contaminants.

It should be noted that there are many possible combinations of various media that can be adequately used for drywash steps 116A and 116B (and subsequent steps, if these are employed). The particular combination of cellulosic absorbent particles followed by ion exchange resin granules is the preferred embodiment. Cellulosic absorbents are generally cheaper than ion exchange resins, and thus by bearing the brunt of contaminant removal, the more expensive ion exchange resin is preserved for a longer time. The ion exchange process also generates free fatty acids from soaps. Thus, if the ion exchange resin encounters too many soaps, the resultant acidity of raw biodiesel 108D may exceed acceptable levels. The removal of soaps through absorption prior to ion exchange prevents this.

The drywash processes 116A and 116B are largely ineffective in removing free methanol 102A from raw biodiesel 108. In fact, many ion exchange resins function most effectively when the raw biodiesel feedstream contains a small percentage of free methanol. Once the drywash steps 116 are concluded, though, trace methanol removal 128 extracts methanol vapor 114B from the feedstream of raw biodiesel 108D, bringing the total quantity to free methanol 102A to within acceptable limits. Thereafter, this feedstream becomes plain biodiesel, being comprised essentially of only fatty acid methyl esters.

After trace methanol removal 128, plain biodiesel feedstream 148 is finished, except for final processing 140. Final processing 140 may include fine filtration, further drywashing and other largely redundant purification process performed as a precaution against contamination, as well as the addition of any chemical additives. Sterol glucosides, which can cause filter plugging in cold weather, may be removed via filtration during final processing 140 as well. In the embodiment shown, plain biodiesel feedstream 148 passes through a bed of activated alumina, and is filtered through diatomaceous earth and finally a simple mechanical filter. Following these filtration steps, an oxidative stabilizer 138 is dosed into the feedstream. The nature of the stabilizer storage 137 is not relevant to the invention, it is only depicted because the invention implies it. These final processes convert the plain biodiesel feedstream into finished biodiesel. The finished biodiesel 141 is now ready for storage or immediate use. The nature of biodiesel storage 143 is not relevant to the invention, it is only depicted because the invention implies it.

Glycerin phase 115, which was separated from the raw biodiesel 108 after phase separation 129A is subjected to glycerin treatment 119. First, free methanol in glycerin phase 115 is removed as methanol vapor 114C by means of elevated temperatures and vacuum. Following this, the soaps in glycerin phase 115 are acidulated using a strong acid. Numerous acids are suitable. The embodiment shown uses hydrochloric acid (HCL) 118. The stoichiometric quantity of acid needed to perform the acidulation varies depending on the level of soap present in glycerin phase 115. In turn, the level of soap present in glycerin phase 115 varies depending primarily on the initial levels of FFAs and moisture in feedstock 106C, as well as the quantity of methylate 105 that was added during reaction 145B. Since the initial level of FFAs can be measured for each batch of feedstock 106C, the quantity of moisture allowed to remain following dehydration 110 is very small, and thus largely repeatable, and the quantity of methylate 105 added during reaction 145B is controlled and thus known, it is possible to determine with reasonable accuracy the appropriate quantity of HCL 118 that should be added to acidulate the soaps present without causing the entire glycerin phase 115 to become highly acidic.

Products of soap acidulation include water, fatty acids, and salts. In the embodiment shown, wherein the alkoxide catalyst is sodium methylate and the acid employed for soap acidulation is hydrochloric acid, the resultant salt 142 produced is sodium chloride, common table salt. Sodium chloride has a lower solubility in glycerin and oils than many other salts. Thus, as the next stage of glycerin treatment 119, dehydration, removes water vapor 120B from the glycerin phase 115, much of the sodium chloride salt 142 precipitates out of solution into solid form. The last step of glycerin treatment 119 involves cooling the raw glycerin 124 to further induce precipitation of salt 142.

Salt removal 125 can be accomplished easily by means of filtration or centrifugation of the raw glycerin 124. Salt 142 is in solid form, and thus is suitable for disposal 131 as solid waste.

Following salt removal 125, the raw glycerin 124 is comprised primarily of glycerin and high FFA oils. These substances are largely immiscible and have different densities, making phase separation 129B a task easily accomplished by gravity. The two distinct phases are high FFA oils 133 and refined glycerin 132.

In the embodiment shown, high FFA oils 133 may be incinerated to produce heat, which is utilized by processes such as feedstock storage 100, particulate removal 107, flow interface 109, dehydration 110, reactions 145, methanol removal 146, glycerin treatment 119, trace methanol removal 128, and methanol purification 136. The incineration of high FFA oils 133 is not essential to the invention and is only depicted because it is included in the invention's preferred embodiment. The high FFA oils 133 have commercial value, and they may be sold or otherwise disposed of.

Refined glycerin 132, while not 100% pure, is of sufficient purity to have commercial value. It may be sold, although its ultimate disposal, as well as glycerin storage 135 are not directly relevant to the invention. Glycerin storage 135 is only depicted because the invention implies it.

Water vapor 120A is removed from feedstock 106C during dehydration 110. Water vapor 120B is also removed from glycerin phase 115 during glycerin treatment 119. It is possible to either condense the water vapor prior to its reaching the vacuum source (while still under vacuum), or to allow the water to pass through the vacuum source, and condensing it afterward. In the preferred embodiment the water vapor 120 is condensed while still under vacuum, simplifying the vacuum generating equipment. This embodiment requires a temperature between 0 and 20 degrees Celsius (32 and 68 Fahrenheit) in the medium temperature condensing 117 step. The liquid water 122A can then be drained 123 and disposed. The nature of the disposal of the water 122A, which is drained 123 after condensation, is not relevant to the invention, it is only depicted because the invention implies it.

Methanol vapor 114A is extracted under vacuum during methanol removal 146. It is possible to either condense the methanol vapor prior to its reaching the vacuum source (while still under vacuum), or to allow the methanol to pass through the vacuum source and condensing it afterward. In the preferred embodiment the methanol vapor 114A is condensed while still under vacuum, thus simplifying the necessary vacuum generating equipment. This embodiment requires a temperature below 20 degrees Celsius (68 Fahrenheit) in the medium temperature condensing 117 step. The condensed raw methanol 126A is contaminated with some quantity of water and this water is removed in methanol purification 136.

The methanol vapor 114B that is extracted during trace methanol removal 128, as well as methanol vapor 114C that is extracted during glycerin treatment 119, is extracted at a lower absolute pressure (deeper vacuum) than the methanol vapor 114A extracted during methanol removal 146. Thus, in order for the methanol vapor 114B to be condensed before the vacuum source (under vacuum), which is the preferred method, the condensation temperature must be lower than that provided by the medium temperature condensing 117, which is limited above 0 degrees Celsius (32 degrees Fahrenheit) by the condensation of water vapor 120. Low temperature condensing 130 takes place at a temperature between −30 and 0 degrees Celsius (−22 and 32 degrees Fahrenheit), ensuring that methanol vapor 114B can still be condensed into raw methanol 126B despite the deeper vacuum.

As with raw methanol 126A, raw methanol 126B will contain contamination from water. Along with raw methanol 126A, it is subjected to methanol purification 136. Methanol purification 136 uses distillation to separate pure methanol from water and other contaminants that are less volatile than methanol. Optionally, a molecular sieve, such as zeolite, may be employed in conjunction with distillation to accomplish methanol purification 136. The purified methanol 102B may then be reused by returning it to methanol storage 103 or joining it to methanol 102A. The water 122B may be drained 123 and disposed of.

The media used in drywashes 116A and 116B will gradually become exhausted as they absorb more and more contaminants. Eventually, these media must be replaced. The spent media 127 is in solid, non-hazardous form, simplifying disposal 131.

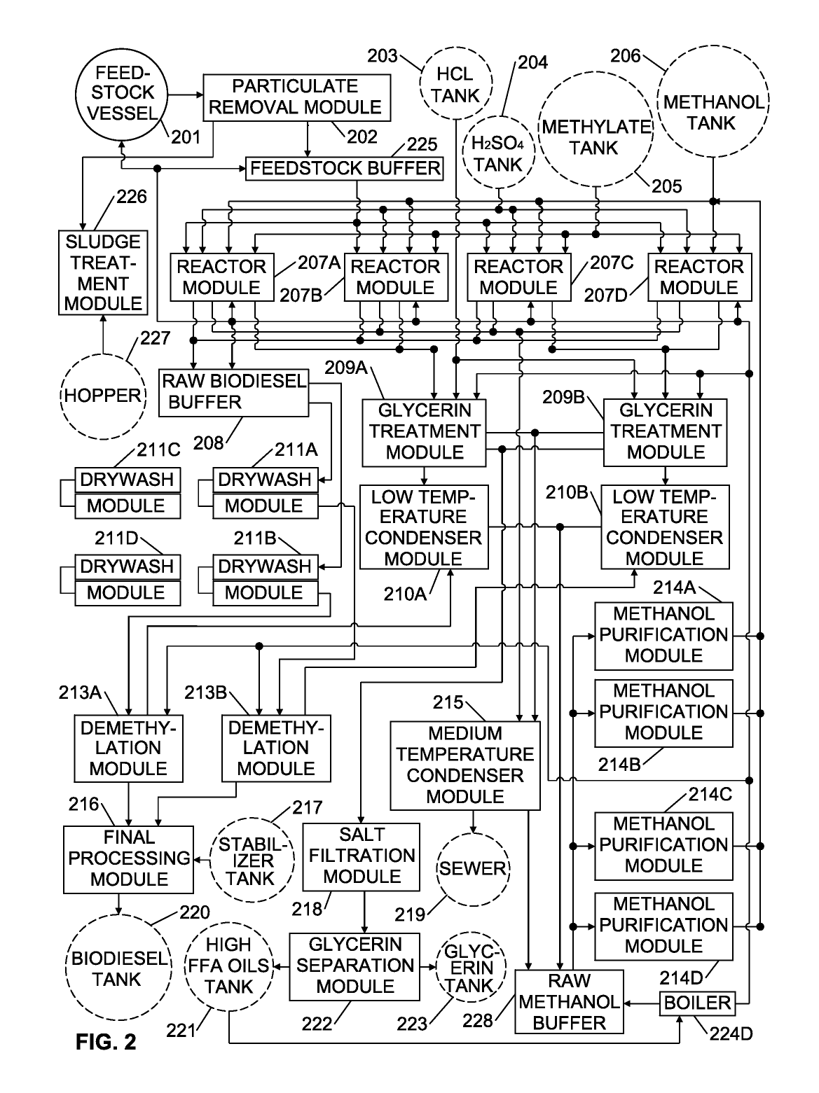

FIG. 2 depicts a schematic for one possible embodiment of the apparatus which executes the process depicted in FIG. 1. The particular embodiment shown may nominally process 3785 liters (1000 gallons) of feedstock per day. FIG. 2 shows only the major modules of the apparatus; other minor devices and major functional components of these modules may be described in the text as needed.

Feedstock vessel 201 is equipped with a heating device and a mixing device to maintain a low viscosity of the feedstock and to prevent stratification of the feedstock and uneven concentrations of particulates and moisture. In the embodiment shown, the temperature of the fluid in feedstock vessel 201 is maintained between 50 and 80 degrees Celsius (122 and 176 degrees Fahrenheit). Feedstock vessel 201 is plumbed to boiler 224, heat transfer fluid from boiler 224 is pumped through a heat exchanger, and feedstock from feedstock vessel 201 is pumped through the other side of the same heat exchanger. This pumping action may serve the dual purpose of warming the feedstock and keeping it homogenous, particularly if the suction port of the pump is plumbed to a location near the bottom of feedstock vessel 201 and the discharge port of the pump is plumbed to a location near the top surface of the liquid within feedstock vessel 201. Alternately, the heating device may be a dedicated heater attached to feedstock vessel 201. In the embodiment shown, such a dedicated heater, in this case an electric heater, is installed in the heat transfer fluid circulation loop on feedstock vessel 201. In the event that boiler 224 is not present or not functional, it can be fluidly decoupled from feedstock vessel 201 by closing valves, and the electric heater can serve to heat the heat transfer fluid. Another device for keeping the feedstock homogenous could be a driven mixing propeller. Feedstock vessel 201 may be equipped with a sampling port. Samples drawn at regular intervals can be tested to determine the free fatty acid level of the feedstock. Feedstock vessel 201 is plumbed to particulate removal module 202.

Particulate removal module 202 may employ filtration, centrifugation, or some other method for removing particulates from the feedstock. Combinations of these methods, such as centrifugation followed by filtration, or multistage filtration by progressively finer filter media, may yield the most efficient results. In the embodiment shown, a self-cleaning filter is used, followed by two finer, disposable filters, such as filter bags or filter cartridges. At any given time, one of these filters is active, while the other stands by ready for use. Once the active filter becomes plugged the fluid flow is diverted through the other filter, leaving the plugged filter accessible for replacement. The continuous flow rate through the filters is maintained at an average of 2.6-3.3 liters (0.69-0.87 gallons) per minute.

Sludge treatment module 226 is plumbed to particulate removal module 202 and receives the sludge ejected by its self-cleaning filter. If a large amount of feedstock is left in the sludge, the sludge treatment module may first drain the sludge through filter media to remove the bulk of the liquid, which may then be returned to feedstock vessel 201 or particulate removal module 202. In the embodiment shown, this is unnecessary, since the quantity of feedstock in the sludge does not warrant these steps. Sludge treatment module 226 receives dry absorbent from hopper 227. In the embodiment shown, the dry absorbent is diatomaceous earth. The sludge and diatomaceous earth are mixed until the liquids are absorbed and the entire mixture can be disposed of as solid waste. Since concentration of fluid in the sludge will be fairly repeatable, the amount of diatomaceous earth needed will also be fairly repeatable, and the variation in quantity needed can be covered by using a slight excess.

Feedstock buffer 225 is plumbed to particulate removal module 202. It is a vessel with a volumetric capacity greater than the combined batch volume capacity of reactor modules 207. In the embodiment shown, in has a liquid capacity of 2688 liters (710 gallons). Feedstock buffer 225 provides a destination for the stream of feedstock coming from particulate removal module 202 and provides a ready source of clean feedstock for reactor modules 207 when these are ready to process a batch. It is equipped with a means of mixing, to keep any moisture present homogenous with the feedstock. In the embodiment shown, this is a motor driven mixing propeller. It is also equipped with a means of heating the feedstock. In the embodiment shown, this is a heat exchanger integrated into the vessel and plumbed to boiler 224, through which heat transfer fluid is circulated by a circulation pump. An additional dedicated electric heater is installed in this circulation loop on feedstock buffer 225. In the event that boiler 224 is not present or not functional, it can be fluidly decoupled from feedstock buffer 225 by closing valves, and the electric heater can serve to heat the heat transfer fluid. Preheating the feedstock in feedstock buffer 225 will save time in reactors 207. In the embodiment shown, it is preheated to between 82 and 93 degrees Celsius (180 and 200 degrees Fahrenheit).

Reactor modules 207A, B, C, and D are identical to one another. Each comprises a reactor vessel as well as smaller temporary storage vessels for methanol, methylate and sulfuric acid. The reactor vessels are airtight and sized to accept 475 liters (125 gallons) of feedstock for each batch, along with the other ingredients used for the batch and some head space above the liquid. In the embodiment shown, the temporary storage vessels for the other ingredients are sized to contain over twice the quantity of each respective ingredient that is used for each batch. For example, up to 10 gallons of methylate may be used for each batch; thus the temporary storage vessel for methanol will be somewhat larger than 20 gallons. This allows each reactor module 207 to dispense the ingredients for two successive batches before these temporary storage vessels must be refilled. Each of the reactor modules 207 is plumbed to feedstock buffer 225.

Before any feedstock is transferred to the reactor modules 207, the reaction vessel of each module is subjected to vacuum. The vacuum source is medium temperature condenser module 215, which is plumbed to each of the reactor modules 207. Feedstock is then transferred at a controlled rate from feedstock buffer 225 to each reactor module 207. In order to prevent the vacuum inside of reactor modules 207 from drawing in feedstock at an uncontrolled rate, feedstock buffer 225 is equipped with four transfer pumps to move the feedstock. One of these transfer pumps sends feedstock to each reactor module 207. Between the discharge port of each transfer pump and its respective reactor module 207, a pressure relief valve with a cracking pressure slightly greater than 1 atmosphere is situated, to counteract the vacuum at the destination.

As the preheated feedstock flows into the reactor vessel of each reactor module 207, most of the moisture boils and is drawn through the plumbed path to medium temperature condenser module 215. If the feedstock were allowed to flow into the reactor vessel at an uncontrolled rate, this boiling might also take place at an uncontrolled rate and result in oil foam travelling to medium temperature condenser module 215. Once the reactor vessels are filled to the appropriate level, the feedstock dehydration is already nearly complete. Completion of feedstock dehydration is determined by the temperature of the feedstock exceeding a minimum value combined with the pressure of the headspace above the liquid in the reactor vessel falling below a maximum value. The reactor vessel may have its own dedicated heater. In the embodiment shown, each reactor module 207 is plumbed to boiler 224, and each reactor module can circulate heat transfer fluid, using a circulation pump, through a heat exchanger integrated into each reactor vessel to heat the liquid inside. An additional dedicated electric heater is installed in this circulation loop on each reactor module 207. In the event that boiler 224 is not present or not functional, it can be fluidly decoupled from any reactor module 207 by closing valves, and the electric heater can serve to heat the heat transfer fluid.

Following dehydration, provided the free fatty acid level of the feedstock is high enough to warrant it, an esterification reaction is performed, using methanol and sulfuric acid from the temporary storage tanks on each reactor module 207. (If the free fatty acid level is very low, the esterification may be skipped.) Before these ingredients are added, the fluid paths to medium temperature condenser module 215 are interrupted by closing a valve on each reactor module 207. In the embodiment shown, the feedstock temperature will be between 88 and 91 degrees Celsius (190 and 196 degrees Fahrenheit) when the esterification begins. Beginning the esterification with the reaction vessel already under full vacuum helps prevent the internal pressure generated by the methanol vapor pressure from exceeding 103 kilopascals (15 pounds per square inch) gauge pressure. By remaining under this pressure threshold, the reactor vessel may be exempted from rigorous pressure vessel regulations which apply to vessels with greater internal pressure. Additionally, the sulfuric acid and methanol are added concurrently. This allows some methanol to immediately begin taking part in the esterification reaction, and thus reduces the amount of free methanol that contributes to the pressure inside the reactor vessel.

The quantities of sulfuric acid and methanol employed are determined based on the FFA level of the feedstock. In the embodiment shown, each reactor vessel is equipped with a driven mixing propeller to agitate the reactants. The driving motor remains outside the reactor vessel, and torque is transmitted through the tank lid to the propeller shaft with a magnetic coupling. The reactor vessel itself has a steep conical bottom to promote complete drainage and accurate phase separation. A small pump is employed to draw liquid from near the top of the reactor vessel and discharge it at the bottom of the conical bottom section of the reactor vessel. This ensures that no pocket of poorly mixed fluid will persist in the reactor vessel.

No heat is added to the reactor vessel as the esterification progresses, unless the temperature falls below a predetermined value, between 65 and 75 degrees Celsius (149 and 167 degrees Fahrenheit). In the embodiment shown, the esterification is determined to be complete when a predetermined amount of time has elapsed. This time may vary from 2 to 6 hours or more. In the embodiment shown, it is 3.5 hours.

The transesterification commences with the movement within each reactor module 207 of methylate from its temporary storage vessel to the reactor vessel. The quantity of methylate is determined based on the initial FFA level of the feedstock. The same agitation method is employed for the transesterification as was employed for the esterification. The transesterification is exothermic, and the temperature of the contents of the reactor vessel will rise soon after it begins. The heaters will also be programmed to run if this temperature falls below 75 degrees Celsius (167 Fahrenheit) during the transesterification. This reaction's completion is also determined by elapsed time. In the embodiment shown, only 0.5 hours are needed.

Immediately following transesterification, methanol is removed from each reactor vessel in vapor form. The mixing propeller continues to agitate the liquid, and the fluid paths between each reactor module 207 and medium temperature condenser module 215 are reestablished by opening valves on each reactor module 207. Medium temperature condenser module 215 again provides vacuum, and methanol vapors are drawn out of each reactor module 207. The latent heat absorbed by the rapid evaporation of methanol quickly cools the liquid inside each reactor vessel. A predetermined pressure vs. temperature curve theoretically represents conditions at which the desired concentration of methanol will be left in the reactor vessel. In the embodiment shown, this curve is defined by the equation

y=1.8706*ê(0.0373x+0.6624)+3.653

wherein y is absolute pressure in kilopascals and x is temperature in degrees Celsius. The pressure and temperature in each reactor vessel are monitored. As soon as they reach this curve, the valve fluidly connecting that reactor module 207 to medium temperature condenser module 215 closes. This results in the pressure-temperature condition in the reactor vessel retreating from the curve until a small, pre-determined gap (dead band) is established, at which point the valve fluidly connecting reactor module 207 to medium temperature condenser module 215 reopens. In the embodiment shown, the opposite boundary of the dead band is the curve defined by the equation

y=1.8706*ê(0.0373x+0.6624)+7.100

wherein y is absolute pressure in kilopascals and x is temperature in degrees Celsius. The pressure-temperature condition in the reactor vessel is maintained within this dead band briefly by cycling of the valve fluidly coupling reactor module 207 to medium temperature condenser module 215, after which the methanol removal is complete, and the valve closes.

Following methanol removal, the heating and agitation of the liquids in each reactor vessel within reactor modules 207 ceases, and air is injected above the liquids to bring the internal pressure back to approximately atmospheric pressure. The glycerin and raw biodiesel phases are allowed to separate. Methods may be employed to accelerate this separation, but in the embodiment shown, no such method is employed, as only 0.5 hours is usually more than adequate to achieve an acceptable degree of separation.

Once the raw biodiesel and glycerin phases are fully separate, reactor modules 207A and 207B send their glycerin phases to glycerin treatment module 209A, to which they are plumbed, while reactor modules 207C and 207D send their glycerin phases to glycerin treatment module 209B, to which they are plumbed. In the embodiment shown, air pressure over the liquid in each reactor vessel is employed to force the liquid out of the reactor vessel and through the plumbing to the respective glycerin treatment module 209. Sensors are employed to discern the phase change from glycerin to raw biodiesel as liquid leaves the reactor tank, and the valves connecting reactor modules 207 with glycerin treatment modules 209 are closed.

All of the reactor modules 207 now send their raw biodiesel phases to raw biodiesel buffer 208, to which they are plumbed. The embodiment shown uses air pressure to force the liquid out of the reactor vessels. Raw biodiesel buffer 208 functions very similarly to feedstock buffer 225. In the embodiment shown, it also employs a vessel with a liquid capacity of 2688 liters (710 gallons). It provides a destination into which reactor modules 207 can rapidly empty their contents, and serves as the reservoir from which drywash lead columns 211 can continuously draw raw biodiesel at a slower controlled rate. Like feedstock buffer 225, raw biodiesel buffer 208 is equipped with a means of mixing, to prevent stratification of the contaminants in the raw biodiesel. In the embodiment shown, this is a driven mixing propeller. It is also equipped with a means of heating the feedstock. In the embodiment shown, this is a heat exchanger integrated into the vessel, and plumbed to boiler 224, through which heat transfer fluid is circulated by a circulation pump located on raw biodiesel buffer 208. A dedicated electric heater is also installed in this circulation loop on raw biodiesel buffer 208. In the event that boiler 224 is not present or is not functional, it may be fluidly decoupled from raw biodiesel buffer 208 using valves, and the electric heater may provide the heat for the circulated heat transfer fluid. In the embodiment shown, the heating is activated if the temperature of the raw biodiesel falls below 38 degrees Celsius (100 degrees Fahrenheit). Alternatively, the mixer in raw biodiesel buffer 208 may not be used, instead allowing stratification of the contaminants in the raw biodiesel. As the raw biodiesel cools, approaching 38 degrees Celsius (100 degrees Fahrenheit), some of these contaminants may precipitate out, and being denser than the raw biodiesel itself, form a small secondary phase at the bottom of the vessel. A drain port near the bottom of the vessel can be used for the removal of this secondary phase. This alternative method may improve the lifespan of the media in drywash modules 211A and 211B.

Raw biodiesel buffer 208 is plumbed to both drywash modules 211A and 211B. These plumbing paths are independent of one another, and each uses a pump to transfer liquid from raw biodiesel buffer 208 to the respective drywash module 211. In the embodiment shown, these pumps have a combined average flow rate of 2.6-3.3 liters (0.69-0.87 gallons) per minute. Raw biodiesel buffer 208 is also equipped with a cooling system and heat exchanger, through which outgoing liquid passes on its way to the inlet port of these pumps. Because the demethylation modules 213 are fluidly coupled to these pumps through the drywash modules 211, the vacuum present in the demethylation modules 213 would tend to pull raw biodiesel from the raw biodiesel buffer 208 at an uncontrolled rate. Thus, a pressure relief valve with a cracking pressure slightly over 1 atmosphere is installed in the plumbing beyond the exit port of each of these pumps. Since, in the embodiment shown, the media in the lead columns of drywash modules 211 is most effective when the temperature of the raw biodiesel is less than 43 degrees Celsius (110 degrees Fahrenheit), this cooling system ensures that the raw biodiesel arriving at drywash modules 211 does not exceed this temperature.

In the embodiment shown, each drywash module 211 has a lead column and a lag column. The lead column is filled with a cellulosic absorbent media, such as wood particles, and the lag column is filled with a granular ion exchange resin, although fewer or more columns may be used, and other media may be employed. The drywash modules 211 remove trace glycerin, soaps, salts and other contaminants from the raw biodiesel feed streams as they flow through the lead and lag columns. The only major contaminant which remains in the biodiesel feedstreams after they pass through the drywash modules is methanol. Once the media in drywash modules 211A and 211B becomes exhausted, feed streams from raw biodiesel buffer 208 are diverted to drywash modules 211C and 211D, which have been standing by, ready for use. This allows the media in drywash modules 211A and 211B to be replaced without interrupting the overall flow from raw biodiesel buffer 208.

Upon exiting the drywash modules 211, each of the two raw biodiesel feed streams enter one of the demethylation modules 213A and 213B. These remove free methanol remaining in the raw biodiesel feed streams. In the embodiment shown, demethylation modules 213 do not operate on discrete batches of raw biodiesel, but rather continuously remove methanol from feed streams of raw biodiesel as they flow through. The feed streams are heated to at least 82 degrees Celsius (180 degrees Fahrenheit) and exposed to vacuum. In the embodiment shown, each feed stream passes through a heat exchanger. The other side of the heat exchanger is plumbed to boiler 224, through which heat transfer fluid is circulated by a circulation pump located on the demethylation module 213. A dedicated electric heater is also installed in this circulation loop on biodiesel demethylation module 213. In the event that boiler 224 is not present or is not functional, it may be fluidly decoupled from demethylation module 213 using valves, and the electric heater may provide the heat for the circulated heat transfer fluid. In the preferred embodiment shown, demethylation modules 213 also use a counterflow heat changer to warm incoming biodiesel and cool outgoing biodiesel.

The vacuum in demethylation module 213A originates from low temperature condenser module 210A, to which it is plumbed, and the vacuum in demethylation module 213B originates from low temperature condenser module 210B, to which it is plumbed. The combination of vacuum and elevated temperature to which the biodiesel feedstreams are subjected cause free methanol to evaporate and be conveyed to the low temperature condenser modules 210. In the embodiment shown, demethylation modules 213 are equipped with special pumps that permit the biodiesel to be pumped out even when subjected to full vacuum. These pumps send biodiesel, at a combined average flow rate of 2.6-3.0 liters (0.69-0.87 gallons) per minute to final processing module 216.

In the embodiment shown, final processing module 216 comprises a pair of columns filled with dry absorbent media for largely redundant removal of trace contaminants, two series of columns filled with media for removal of sterol glucosides, two mechanical filters, and a reservoir and dispensing pump for injecting an oxidative stability increasing chemical into the biodiesel feed stream. At any given time, only one of the absorbent media columns, one of the sterol glucoside removal column series, and one of the two mechanical filters are active. Their alternates stand by, so that in the event that the media in any one of these elements becomes exhausted or clogged, flow may divert to its alternate, allowing the clogged media to be replaced without interruption of flow. In the embodiment shown, pumps are employed to boost the pressure of the biodiesel feed stream, since the pumps of the demethylation modules 213 may not generate enough pressure. The particular selection and arrangement of elements in the embodiment shown is only one of many possible for final processing module 216.

After passing through final processing module 216, the biodiesel is complete and ready for usage, sale, transport or storage. In the embodiment shown, the finished biodiesel feed stream terminates at biodiesel tank 220, where samples may be drawn for quality control testing.

Glycerin treatment module 209A receives batches of glycerin phase from reactor modules 207A and 207B. Glycerin treatment module 209B receives batches of glycerin phase from reactor modules 207C and 207D. In the embodiment shown, the glycerin treatment modules comprise an airtight treatment vessel, an HCL storage vessel, a defoamer storage vessel, a heat exchanger integrated into the treatment vessel, a mixing propeller in the treatment vessel, a liquid cooling system, and a liquid heating system. The treatment vessel is sized to accept 200 liters (53 gallons) of glycerin phase, with some head space above the liquid. The HCL storage vessel holds slightly more than the quantity that might be required to treat two batches of glycerin phase, in this case 38 liters (10 gallons). Because only a trace amount of defoaming chemical is used per batch, the defoamer storage vessel holds enough for dozens of batches.

In the liquid heating system of the embodiment shown for glycerin treatment module 209, the treatment vessel's heat exchanger is plumbed to boiler 224, and heat transfer fluid is circulated using a circulation pump. A dedicated electric heater is also installed in this circulation loop on the glycerin treatment module 209. In the event that boiler 224 is not present or not functioning, it may be fluidly decoupled from the glycerin treatment module 209 by closing valves, and the electric heater can provide the heating of the heat transfer fluid. The liquid cooling system utilizes the same treatment vessel heat exchanger and circulation pump as the liquid heating system. When the liquid cooling system is active, the glycerin treatment module 209 is fluidly decoupled from boiler 224. The now isolated heat transfer fluid continues to be circulated through the treatment vessel heat exchanger, while a secondary kidney loop becomes active. This comprises a further circulation pump, a fan and a radiator for expelling heat. While the kidney loop is active, the heat transfer fluid is cooled, thus cooling the contents of the treatment vessel.

Glycerin treatment module 209A is plumbed to low temperature condenser module 210A, and glycerin treatment module 209B is plumbed to low temperature condenser module 210B. After a glycerin treatment module 209's treatment vessel receives a batch of glycerin, a small dose of defoaming chemical is added. The liquid inside is heated and stirred, and vacuum, originating from one of the low temperature condenser modules 210, is applied, causing free methanol to evaporate and be drawn into the low temperature condenser module 210. The methanol removal is complete once a pressure and temperature target in the treatment vessel is achieved. Next, HCL is dispensed into the treatment vessel, causing the soaps present in the glycerin phase to be acidulated into water, fatty acids, and salt. Both glycerin treatment modules 209 are plumbed to medium temperature condenser module 215. Following the soap acidulation, vacuum, originating from medium temperature condenser module 215, is applied, causing water to evaporate and be drawn into medium temperature condenser module 215. Water removal is complete once a pressure and temperature target in the treatment vessel is achieved. Following water removal, the liquid in the treatment vessel is cooled to encourage precipitation of salts.

In the embodiment shown, air pressure is used to force the liquid contents (raw glycerin) out of the treatment vessel's drain valve. The raw glycerin is forced through salt filtration module 218, which is plumbed to the glycerin treatment modules 209. In the embodiment shown, salt filtration module 218 consists of a filter press and a bin into which the captured salt can be emptied.

Upon exiting salt filtration module 218, the raw glycerin flows to glycerin separation module 222, to which it is plumbed. In the embodiment shown, this consists of a settling tank, in which the high FFA oils separate from the glycerin. The oils are transferred through plumbing to high FFA oils tank 221, and the glycerin is transferred to glycerin tank 223. The high FFA oils are transferred through plumbing to boiler 224, where they are combusted for heat. The glycerin in glycerin tank 223 has now been purified to an extent that renders it saleable.

Medium temperature condenser module 215 receives water vapor from reactor modules 207 and glycerin treatment modules 209. It also receives methanol vapor from reactor modules 207 and in the event that of an over-pressurization or other system fault, most of the modules in the system have pressure relief ports or vapor breather ports that are plumbed to medium temperature condenser module 215. Medium temperature condenser module 215 comprises a thermal storage vessel, a water condensate vessel, a methanol condensate vessel, a fume condensate vessel, a methanol vacuum pump, a water vacuum pump, a chiller, a methanol heat exchanger, a water heat exchanger, a fume heat exchanger, a chiller circulation pump, a methanol heat exchanger circulation pump, a water heat exchanger circulation pump, and a fume heat exchanger circulation pump.

The thermal storage vessel of medium temperature condenser module 215 contains a large volume of heat transfer fluid. In the embodiment shown, it contains about 1880 liters (500 gallons) of a water/glycol solution. The chiller circulation pump circulates this heat transfer fluid through the chiller, eventually cooling the entire mass of liquid. The water, methanol, and fume condensate vessels, as well as the water, methanol and fume heat exchangers are submerged in this liquid. The water heat exchanger circulation pump circulates cooled heat transfer fluid through the water heat exchanger, the methanol heat exchanger circulation pump circulates cooled heat transfer fluid through the methanol heat exchanger, and the fume heat exchanger circulation pump circulates cooled heat transfer fluid through the fume heat exchanger. The water vacuum pump applies vacuum to the water condensate vessel, the methanol vacuum pump applies vacuum to the methanol condensate vessel, and the fume condensate vessel is plumbed to the atmosphere.

Methanol vapors entering medium temperature condensing module 215 are cooled and condensed in the methanol heat exchanger, and the condensate collects in the methanol condensate vessel. Water vapors entering medium temperature condensing module 215 are cooled and condensed in the water heat exchanger, and the condensate collects in the water condensate vessel. Fumes entering medium temperature condensing module 215 are cooled and condensed in the fume heat exchanger, and the condensate collects in the fume condensate vessel. When one of these condensate vessels become full, valves isolate it from the rest of the system. Its associated vacuum pump, if any, pauses, and air pressure is used to force the condensate out of the vessel, and through plumbing to the methanol purification modules 214 if the condensate is raw methanol, to sewer 219 if the condensate is water, or into an inspection vessel if the condensate came from fumes. Such an inspection vessel is not depicted in FIG. 2 since it will very rarely be used in normal operation of the apparatus. Following the emptying of the condensate vessel, the associated vacuum pump reestablishes vacuum in the condensate vessel, and the valves isolating it from the rest of the system are reopened.

Since the medium temperature condenser module handles both water and methanol fumes, the heat transfer fluid contained in the thermal storage vessel must remain warmer than 0 degrees Celsius (32 Fahrenheit) to prevent the water vapor from freezing. When deep vacuum is applied to methanol though, it may require a temperature lower than this to condense the vapors. Low temperature condenser modules 210 provide deep vacuum to the glycerin treatment modules 209 and the demethylation modules 213, along with a condensing system sufficiently cold to ensure complete condensation of the methanol vapors. Low temperature condenser module 210A is plumbed to glycerin treatment module 209A and demethylation module 213A, while low temperature condenser module 210B is plumbed to glycerin treatment module 210B and demethylation module 213B.

Each low temperature condenser module 210 is comprised of a chiller, a heat exchanger, a condensate vessel, a vacuum pump, and a discharge pump. The vacuum pump applies vacuum to the condensate vessel, which is fluidly coupled to the heat exchanger. One side of the heat exchanger (the side not fluidly coupled to the vacuum pump) is cooled by the chiller, while methanol vapors flow into the other side. These condense in the heat exchanger and collect in the condensate vessel. The discharge pump is a special type which allows raw methanol condensate to be pumped out even when under nearly full vacuum.

Methanol purification modules 214A, B, C, and D separate pure methanol from water and other contaminants present in the raw methanol condensed by the medium temperature condenser module 215 and the low temperature condenser modules 210. In the embodiment shown, each methanol purification module 214 has a distillation pot with a liquid capacity of 636 liters (168 gallons) and purifies raw methanol at a rate of about 3.79 liters (1 gallon) per hour. This combined purification capacity of 363 liters (96 gallons) per day outpaces the average of 348 liters (90 gallons) per day of raw methanol generated by the entire apparatus. Since each methanol purification module 214 must finish its current batch before it can accept new raw methanol, raw methanol buffer 228 is used by the methanol purification modules 214 to receive raw methanol from the medium temperature condenser module 215 and the low temperature condenser modules 210, and then rapidly fill any methanol purification module 214 that is ready for a fresh batch of raw methanol. In the embodiment shown, raw methanol buffer 228 has a liquid capacity of 240 gallons.

The methanol purification modules 214 distill pure methanol from the raw methanol in the distillation pot. In the embodiment shown, this purified methanol is discharged by each purification module 214 into a common discharge buffer vessel. This allows sampling for quality control testing before this purified methanol is transferred back to methanol tank 206. The liquid capacity of this discharge buffer vessel is 240 gallons. The heat for distillation may be provided by a dedicated heater, installed in each individual methanol purification module 214, or it may be obtained via heat transfer fluid from boiler 224. In the embodiment shown, the distillation pot in each methanol purification module 214 includes an integrated heat exchanger. Hot heat transfer fluid may flow through this heat exchanger to transfer heat to the contents of the distillation pot. This heat transfer fluid is heated by a dedicated electric heater installed in each methanol purification module 214.

Raw methanol buffer 228 includes a means of warming the raw methanol it holds. In the embodiment shown, it is a heat exchanger, through which heat transfer fluid from boiler 224 is circulated. The heating is regulated not to exceed 63 degrees Celsius (145 degrees Fahrenheit). By preheating the raw methanol, the methanol purification modules 214 can begin distillation almost immediately when they receive the raw methanol, rather than waiting for cold raw methanol to warm up to distillation temperature.

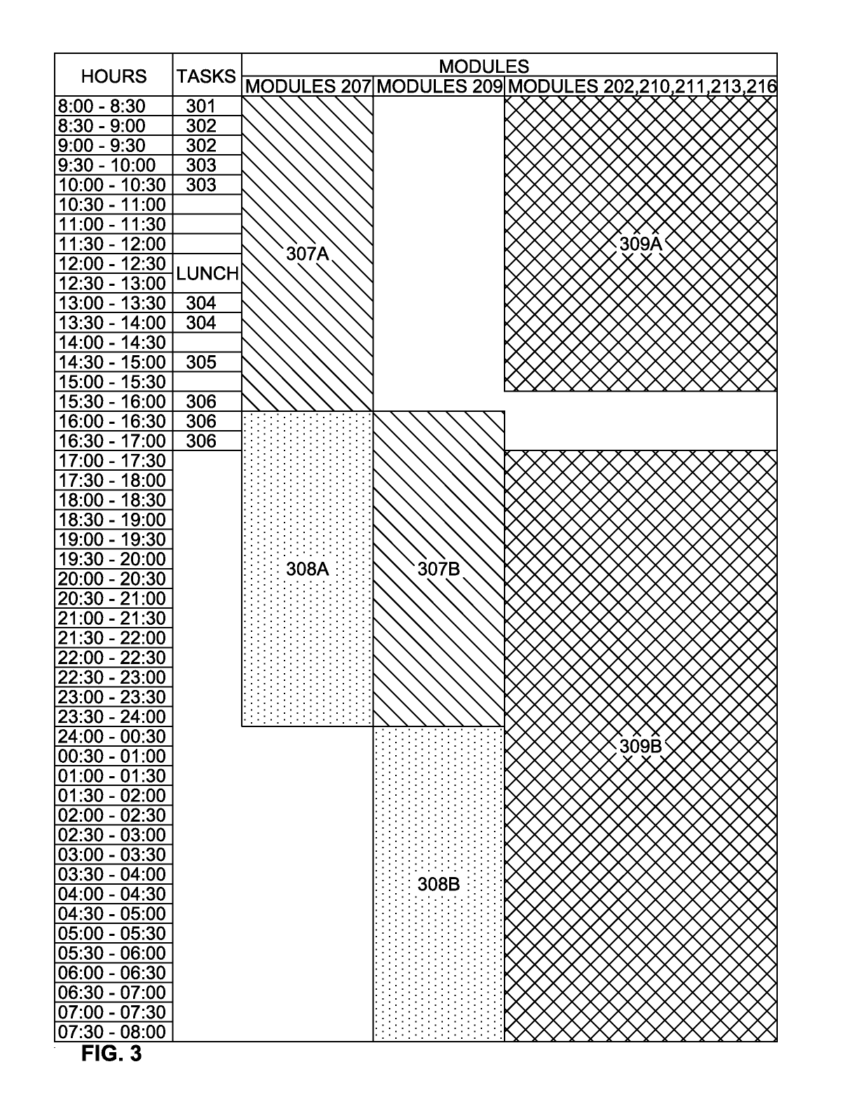

FIG. 3 is a timetable, spanning a representative 24 hour period. This table depicts the scheduling of technician tasks along with the times during which modules whose operation drive the production schedule are active. This time table is in accordance with the same embodiment shown in FIGS. 1 and 2.

The hatched areas of FIG. 3 represent discrete batches of feedstock or the wastes derived from these. The slant-hatched area 307A represents a given batch of feedstock while it occupies reactor modules 207. The slant-hatched area 307B represents the glycerin phase derived from feedstock batch 307A. The dot-hatched area 308A represents a subsequent batch of feedstock while it occupies reactor modules 207. The dot-hatched area 308B represents the glycerin phase derived from feedstock batch 308A. The cross-hatched areas 309A and 309B represent all of the time during which particulate removal module 202, low temperature condenser modules 210, drywash modules 211, demethylation modules 213 and final processing module 216 must be active. The liquids undergoing processes in these modules are not derived from distinctly separate batches of feedstock. The portion of FIG. 3 labeled “TASKS” represents a technician's work shift.

The entire schedule may be shifted earlier or later. The schedule depicted may be the preferred embodiment, since it allows the technician to work a shift with a standard starting time. The modules represented in areas 309 do not necessary need to pause as shown. Startup and shutdown is usually more complex than continuous operation, and those modules that commonly require media replacements, such as drywash 211 and final processing module 216 are already configured to allow media replacement to be performed without interrupting operation. If, however, one of these modules requires a pause, the system can accommodate it.

Task 301 is overall inspection of the system. This includes supervising the batch liquid transfers to and from reactor modules 207. Task 302 involves drawing samples of feedstock, finished biodiesel, and purified methanol, and performing quality control testing them. Task 303 is bulk transfer of fluids. This might include receiving deliveries of feedstock or ingredients from suppliers, loading trucks to haul away finished biodiesel, etc. If the one hour shown is inadequate for task 303, an additional unallocated 1.5 hours are available immediately after the time already set aside. Task 304 is the loading of methanol, methylate, and sulfuric acid into reactor modules 207 and the loading of hydrochloric acid into glycerin treatment modules 209. Enough of these ingredients are loaded for two batches of processing. Task 305 is logging and recording of pertinent information. Task 306 is replacing any exhausted media present in particulate removal module 202, drywash module 211, and final processing module 216. During this time, the fluid transfers to and from reactor modules 207 are supervised.

Once task 306 is complete, the entire system may function unsupervised until the following day's shift by means of uncomplicated automation. During the technician's work shift, the quantity of tasks that must be completed are not overly demanding. The times shown for each task are liberal estimations, and there is significant unallocated time for unexpected tasks that may arise. By processing two batches of feedstock per day, a total of 3785 liters (1000 gallons) is processed.

FIG. 3 serves to illustrate the flexibility of the apparatus in terms of production capacity. For instance, by shifting the entire production schedule slightly later, and adding another half work shift for an additional technician, a third batch could be processed each day, increasing output by 50%. Since the particulate removal module 202, the drywash module 211, the demethylation module 213, and the final processing module 216 may accommodate some increase in feed rate beyond the nominal average, this major increase in production capacity of the entire apparatus might be accomplished with only the addition of two methanol purification modules 214. Or, if the addition of a second, part-time technician is unacceptable, output might be increased 25% by the addition of just one reactor module 207 and one methanol purification module 214. Upon examination, it becomes apparent that through a degree of throughput flexibility in the modules that operate on a continuous feed stream, combined with the option of adding work shifts, and the ability to enlarge the system on a module-by-module basis, the number of possible permutations and combinations result in a highly customizable system that may be adapted very efficiently to considerations of human labor, site layout, feedstock supply, cost and availability of utilities, etc., to maximize the earning potential of the apparatus.

We claim:

1. A system for making biodiesel from feedstock comprising:
a feedstock vessel for storing said feedstock, said feedstock vessel having a first heater and a first mixer, said first heater warming said feedstock to maintain a low viscosity, said first mixer agitating said feedstock to keep the contaminants in said feedstock dispersed in a largely homogenous manner, said contaminants in said feedstock comprising a first water phase and particulates;
a particulate removal module for removing particulates from said feedstock in a continuous feedstock feedstream, being fluidly coupled by plumbing to said feedstock vessel, having a first outlet port, having a first pump for transferring said feedstock from said feedstock vessel and through said particulate removal module to said first outlet port;
a feedstock flow buffer module for receiving said continuous feedstock feedstream from said particulate removal module, having a feedstock holding vessel fluidly coupled by plumbing to said first outlet port, said feedstock holding vessel having a second heater to warm its contents, a second mixer to agitate its contents, and a second pump for removing contents from said feedstock holding vessel;
a reactor module comprising a reactor vessel, said reactor vessel having a volume less than that of said feedstock holding vessel and having a third heater to warm its contents and a third mixer to agitate its contents, being fluidly coupled by plumbing to said second pump, receiving said feedstock feedstream from said second pump while simultaneously subjecting said reactor vessel to vacuum and warming said feedstock feedstream as it enters said reactor vessel to extract said first water phase therefrom as a first water vapor, said reactor vessel having a first water vapor discharge port, said first water vapor being removed through said first water vapor discharge port, said reactor vessel having a predetermined batch volume, alcohol and alkoxide catalyst being released into said reactor vessel when the volume of said feedstock reaches said batch volume, said alcohol and alkoxide catalyst being reacted with said feedstock, being agitated by said third mixer for a predetermined time to perform a transesterification reaction forming a raw biodiesel phase and a raw glycerin phase, the quantity of said alcohol employed in said transesterification being in excess of the stoichiometric quantity required for said transesterification reaction, the difference between said quantity of said alcohol employed in said transesterification and said stoichiometric quantity of said alcohol required for said transesterification forming an excess alcohol phase, said reactor vessel then being subjected to vacuum while said raw biodiesel phase and said raw glycerin phase are being agitated by said third mixer to extract a first portion of said excess alcohol phase as a first alcohol vapor, a second portion of said excess alcohol phase remaining with said raw biodiesel phase and a third portion of said excess alcohol remaining with said raw glycerin phase, said reactor vessel having a first alcohol vapor discharge port, said first alcohol vapor being removed through said first alcohol vapor discharge port, said reactor vessel then being returned to atmospheric pressure and said raw biodiesel and raw glycerin phases separating within said reactor vessel, said raw biodiesel phase comprising essentially fatty acid alkyl esters, said second portion of said excess alcohol phase, trace soaps, trace glycerin, and trace salts; said raw glycerin phase comprising essentially glycerin, said third portion of said excess alcohol phase, soaps, oils, and salts; the greater density of said raw glycerin phase causing it to form a lower layer, said reactor vessel having a sloped bottom surface to facilitate draining and having a drain port located near the bottom of said sloped bottom surface, said glycerin phase and said raw biodiesel phase then being sequentially removed from said reactor vessel through said drain port;
a raw biodiesel flow buffer module for receiving said raw biodiesel phase from said reactor module, having a raw biodiesel holding vessel having a volume greater than that of said reactor vessel and being fluidly coupled by plumbing to said reactor vessel drain port, and having a third pump for removing contents from said raw biodiesel holding vessel;
a drywash module, having a drywash vessel containing a drywash media bed for removing said trace soaps, said trace glycerin and said trace salts from said raw biodiesel, said drywash vessel having a first inlet port and third outlet port, said first inlet port being fluidly coupled to said third pump by plumbing, said third pump causing said raw biodiesel to pass through said drywash media bed in a continuous raw biodiesel feedstream;
a dealkylation module for removing said second portion of said excess alcohol phase from said raw biodiesel feedstream, having a boiling vessel fluidly coupled to said third outlet port, said boiling vessel having a fourth heater, vacuum being applied to said boiling vessel, said raw biodiesel feedstream passing through said boiling vessel, said second portion of said excess alcohol in said raw biodiesel feedstream vaporizing to form a second alcohol vapor, said boiling vessel having a second alcohol vapor discharge port, said second alcohol vapor being essentially removed through said second alcohol vapor discharge port, said removal of said second alcohol vapor leaving behind a plain biodiesel phase, said boiling vessel having a biodiesel discharge pump, said biodiesel discharge pump expelling said plain biodiesel phase in a plain biodiesel feedstream at the same average flow rate as incoming said raw biodiesel feedstream;
a glycerin treatment module for isolating said glycerin from said raw glycerin phase, said glycerin treatment module having a glycerin treatment vessel and an acid vessel, said glycerin treatment vessel having a fifth heater, a fourth mixer, a second inlet port, and a cooler; said second inlet port being fluidly coupled by plumbing to said reactor vessel drain port, said glycerin treatment vessel receiving said raw glycerin phase from said reactor vessel, vacuum being applied to said glycerin treatment vessel while said fourth mixer agitates said glycerin phase causing said third portion of said excess alcohol phase to vaporize, said glycerin treatment vessel having a third alcohol vapor discharge port, said third portion of said excess alcohol phase being removed through said third alcohol vapor discharge port; said acid vessel then releasing an acid into said glycerin treatment vessel wherein said fourth mixer agitates said acid and said raw glycerin phase to perform a soap acidulation on said soaps present in said raw glycerin phase; said raw glycerin phase being divided into two phases, an oil phase, comprised essentially of said oils, and a glycerin phase, comprised primarily of said glycerin, said soap acidulation creating additional oils, said additional oils combining with said oil phase to enlarge said oil phase, said soap acidulation creating a second water phase, said second water phase dissolving into said glycerin phase, said soap acidulation creating a salt phase, said salt phase absorbing said salts, and said salt phase being dissolved into said oil phase and said glycerin phase; vacuum then being applied to said glycerin treatment vessel while said fourth mixer agitates said glycerin phase and said oil phase causing said second water phase to vaporize into a second water vapor, said glycerin treatment vessel having a second water vapor discharge port, said second water vapor being removed through said second water vapor discharge port; said glycerin phase and said oil phase then being sufficiently cooled by said cooler to allow the majority of said salt phase to precipitate out of said glycerin phase and said oil phase; and said glycerin treatment vessel having a fourth outlet port for the removal of the contents of said glycerin treatment vessel;
a salt filtration module having a filter element, said filter element being fluidly coupled by plumbing to said fourth outlet port, said glycerin phase and said oil phase passing through said filter element; and said salt phase being retained in said filtration device;
a glycerin separation module, having a separation vessel, said separation vessel having a third inlet port, a glycerin removal port near the bottom of said separation vessel, and an oil removal port situated substantially higher on the side of said separation vessel, said separation vessel being fluidly coupled by plumbing to said filtration device, receiving said glycerin phase and oil phase, said glycerin phase and oil phases separating into distinct layers according to their respective densities within said separation vessel, said glycerin phase being removed through said glycerin removal port and said oil phase being removed through said oil removal port;
a medium temperature condensing module, having a first vacuum generator, a first chiller, a water vapor condensing heat exchanger, a first alcohol vapor condensing heat exchanger, a water condensate vessel, a first alcohol condensate vessel, a volume of liquid coolant, a chiller heat exchanger to transfer heat from said coolant to said first chiller, circulation pumps to circulate said coolant through said water vapor condensing heat exchanger, first alcohol vapor condensing heat exchanger, and chiller heat exchanger; said water vapor condensing heat exchanger having an inlet being fluidly coupled by plumbing to said first water vapor discharge port and said second water vapor discharge port, said first alcohol vapor heat exchanger being fluidly coupled by plumbing to said first alcohol vapor discharge port, said chiller maintaining the temperature of said coolant between 0 and 20 degrees Celsius (32 and 68 degrees Fahrenheit), said first vacuum generator being fluidly coupled to said water condensate vessel and first alcohol condensate vessel, said water condensate vessel being fluidly coupled to said water vapor heat exchanger, said first alcohol condensate vessel being fluidly coupled to said first alcohol vapor heat exchanger, said first vacuum generator having a fluid path for applying vacuum to said reactor vessel and said glycerin treatment vessel, said vacuum being communicated or cut off by means of valves situated in said plumbing between said medium temperature condensing module and said reactor vessel and glycerin treatment vessel, said first water vapor and said second water vapor being condensed into a water condensate phase in said water vapor condensing heat exchanger and then accumulating in said water condensate vessel, said first alcohol vapors being condensed into a first alcohol condensate phase in said first alcohol vapor condensing heat exchanger and then accumulating in said first alcohol condensate vessel, said first alcohol condensate phase comprising mostly alcohol along with some dissolved water and some dissolved oils; and said water condensate vessel having a water condensate drain port and said first alcohol condensate vessel having an alcohol condensate drain port;
a low temperature condenser module, having a second vacuum generator, a second chiller, a second alcohol vapor heat exchanger, a second alcohol condensate vessel, and an alcohol discharge pump; said second alcohol vapor heat exchanger being chilled by said second chiller, said second alcohol vapor heat exchanger having an inlet fluidly coupled by plumbing to said second alcohol vapor discharge port and said third alcohol vapor discharge port, said second alcohol vapor heat exchanger having an outlet fluidly coupled to said second alcohol condensate vessel, said second alcohol vapors and said third alcohol vapors being condensed in said second alcohol vapor heat exchanger into a second alcohol condensate phase, said second alcohol condensate phase comprising mostly alcohol along with some dissolved water and some dissolved oils, said second alcohol condensate phase accumulating in said second alcohol condensate vessel, said alcohol discharge pump being fluidly coupled to said second alcohol condensate vessel and discharging said second alcohol condensate phase from said second alcohol condensate vessel as it accumulates therein;
an alcohol purification module, being fluidly coupled to said alcohol condensate drain port and said alcohol discharge pump, and receiving said first alcohol condensate phase and said second alcohol condensate phase, said first alcohol condensate phase combining with said second alcohol condensate phase to form a raw alcohol phase; said dissolved water and said dissolved oils being essentially removed from said raw alcohol phase to create a purified alcohol phase, said purified alcohol phase being available for reuse in said transesterification reaction;
valves being located in said plumbing fluidly coupling said modules to allow interruption of said fluid coupling as needed;
wherein the physical layout of said modules is flexible, their relative positions to one another being adjustable according to the shape of the available installation side, changes in physical layout being accommodated by changing the said plumbing fluidly coupling the said modules to one another.

2. The system as recited in claim 1, further comprising a final processing module, having 1 or more media cartridges for the absorption of sterol glucosides from said fatty acid alkyl ester feedstream, and a means of adding a controlled continuous dose of an oxidative stabilization chemical; said fatty acid alkyl ester feedstream being received from said biodiesel discharge pump, passing through said 1 or more media cartridges, said sterol glucoside content of said fatty acid alkyl ester feedstream being thereby reduced, said controlled continuous dose of said oxidative stabilization chemical being added to said fatty acid alkyl ester feedstream, and said fatty acid alkyl ester feedstream thereby becoming finished biodiesel.

3. The system recited in claim 2, wherein said alcohol is methanol, and said alkoxide catalyst is sodium methylate.

4. The system recited in claim 2, wherein following the removal of said first water vapor and prior to performing said transesterification reaction, an esterification reaction is performed within said reactor vessel, alcohol and an acid catalyst being released into said reactor vessel, and being agitated by said second mixer.

5. The system recited in claim 4, wherein said alcohol is methanol, said alkoxide catalyst is sodium methylate, and said acid catalyst is sulfuric acid.

6. The system recited in claim 1, wherein said particulate removal module comprises a self cleaning filter followed by 2 or more finer, disposable filters, wherein at any given time at least one of said disposable filters is in use and at least one of said disposable filters is standing by ready for use should another of said disposable filters become clogged.

7. The system recited in claim 6, further comprising a sludge treatment module for converting slurry removed from said self cleaning filter into solid waste, such conversion being accomplished by a portion of the liquid phase of said slurry being drained out of said slurry through a filter element; the remaining portion of said liquid phase of said slurry being absorbed by a solid absorbent.

8. The system recited in claim 7, wherein said solid absorbent is diatomaceous earth.

9. The system recited in claim 1, further comprising a boiler and heating fluid distribution system wherein fluid heated by said boiler is circulated to those modules utilizing a heater, said heating fluid delivering heat to said modules through heat exchangers, and said heat exchangers serving as said heaters for said modules.

10. The system recited in claim 9, wherein said boiler is at least partially fueled by said oil phase from said separation vessel.

11. The system recited in claim 1, wherein said drywash module comprises 2 or more sets of drywash media beds, each said set of media beds comprising a first media bed of a cellulosic absorbent media and a second media bed of granular ion exchange resin media, wherein at any given time one or more said sets of media beds is in use while one or more said sets of media beds is standing by, ready for use should the media from another said set of media beds become exhausted.

12. The system recited in claim 3, wherein said acid employed in said glycerin treatment module is hydrochloric acid, and said salt phase produced by said soap acidulation is sodium chloride.

13. The system recited in claim 3, wherein said alcohol purification module utilizes a fractioning column to separate said dissolved water and said dissolved oils from said raw alcohol phase.

14. The system recited in claim 5, wherein said reactor module further comprises a methanol vessel, a sodium methylate vessel, and a sulfuric acid vessel, said methanol vessel sized to hold enough methanol for said esterification and transesterification reactions for at least 2 said batch volumes of said feedstock, said sodium methylate vessel sized to hold enough sodium methylate for said transesterification reactions for at least 2 said batch volumes of said feedstock, said sulfuric acid vessel sized to hold enough said sulfuric acid for said esterifications reactions for at least 2 said batch volumes of feedstock, said methanol vessel fluidly coupled by plumbing to said reactor vessel and releasing said methanol into said reactor vessel as required for said esterification and transesterification reactions, said sodium methylate vessel fluidly coupled by plumbing to said reactor vessel and releasing sodium methylate into said reactor vessel as required for said transesterification reaction, and said sulfuric acid vessel fluidly coupled by plumbing to said reactor vessel and releasing sulfuric acid into said reactor vessel as required for said esterification reaction.

15. The system recited in claim 14, wherein the said processes performed by all said modules are monitored and controlled by a computer automation system.

16. The system recited in claim 15, wherein two or more said reactor modules are simultaneously employed, and the number of other said modules is also increased as needed to match the throughput capacity of said reactor modules.

17. The system recited in claim 16, wherein said system processes 2 batch volumes of said feedstock from each said reactor module per day, the operations performed by said system being timed such that all recurring peripheral tasks not conducive to automation, such as taking away said solid waste or refilling said methanol vessels can be accomplished by a human operator within a 9 hour time window, said time window recurring at the same time each day.

18. The system recited in claim 17, wherein at any given time, the total combined volume of said feedstock and said raw biodiesel in said system, excluding said feedstock vessel, does not exceed 2 times the nominal daily production capacity volume of said system.
